(19) United States
(12) Patent Application Publication
(10) Pub. No.: US 2009/0177554 A1
(43) Pub. Date: Jul. 9, 2009

(54) METHOD AND SYSTEM FOR FACILITATING TRANSFER OF AN INTELLECTUAL ASSET

(76) Inventor: Matthew David Powell, Georgetown (CA)

Correspondence Address: SIM & MCBURNEY, 330 UNIVERSITY AVENUE, 6TH FLOOR, TORONTO, ON, M5G 1R7, CA

(21) Appl. No.: 12/296,851

(22) PCT Filed: Apr. 13, 2007
(86) PCT No.: PCT/CA2007/000611

§ 371 Date: Oct. 10, 2008

Related U.S. Application Data
(60) Provisional application No. 60/744,753, filed on Apr. 13, 2006.

(51) Int. Cl. G06Q 30/00; G06Q 50/00; G06F 17/30

(52) U.S. Cl. 705/26; 707/104.1; 707/E17.044

(57) ABSTRACT

A system for facilitating transfer of an intellectual asset includes a data interface receiving electronic patent application data respecting a primary patent application. A processor creates a plurality of option records, each option record respectively including data relating to an option to file a patent application in a respective secondary jurisdiction based on the primary patent application. A storage device stores the plurality of option records and a first input device interface receives authorization to make at least one option individually available for transfer. The processor modifies at least one option record in accordance with the authorization, and a second input device permits third parties to view data relating to which options are individually available for transfer.

### FIELD OF THE INVENTION

The system and methods disclosed herein relate generally to intellectual asset management, and more particularly to a method and system for transferring an intellectual asset.

### BACKGROUND OF THE INVENTION

Small inventors and early-stage companies often suffer from difficulties obtaining financing prior to revenue, for securing patent protection and producing products in target jurisdictions. Investors often want to see that patent protection has at least been applied for. If securing patent protection in all patent-granting jurisdictions around the world were simple and inexpensive, an Applicant would likely simply file in all jurisdictions and prosecute applications until they are granted. The Applicant would then seek those interested in taking out a license or licenses for the respective jurisdictions, having undertaken little risk that they would not be able to at least recoup their investment in the patenting procedure.

However, securing patent protection is extremely expensive. This is because patent law and procedure can be extremely complex, varies between patent-granting jurisdictions, and often requires the specialized skills of a patent agent or attorney knowledgeable in the peculiarities of their particular jurisdiction. Further costs include translations, and periodic payment of maintenance fees.

It is often the case that Applicants are interested in securing patent protection in only a select few jurisdictions where it is felt that there is some likelihood of receiving a positive return on their investment. For example, a small Canadian inventor may wish to simply secure patent protection in the United States of America and Canada, and proceed with the help of the patent protection to develop a business in the two countries. Any remaining budget available to the Canadian inventor is focused on product development, sales, marketing, advertising, personnel and so forth in and for these two countries. Occasionally, a business owner's sole focus, at least at the early stages of the business, is a single country's market.

An applicant for patent may wish to take advantage of an International, bilateral or other type of agreement in order to assist with deferring costs associated with the patenting process. For example, under the Paris Convention For The Protection of Industrial Property (known as the “Paris Convention”), an applicant filing on a first filing date a patent application for an invention in one jurisdiction party to the Paris Convention may file subsequent patent applications for the invention in other jurisdictions also party to the Paris Convention within twelve months, and retain the “priority” benefit of the first filing date for the subsequent patent applications. In other words, an applicant can file in one jurisdiction and wait 12 months to undertake filing in one or more other jurisdictions without risking patentability of the invention in the one or more other jurisdictions. This 12 month deferral “tool” allows the Applicant to, among other things, market the invention and secure financing without the having to pay for patenting all up-front. Further details on the Paris Convention can be found at http://www.wipo.int.

The Patent Cooperation Treaty (“PCT”), administered by the World Intellectual Property Organization (“WIPO”), is another tool available to patent applicants. Under the PCT, an applicant resident in one of the jurisdictions party to the PCT (“Contracting State”) may file a single International patent application for an invention and, at the time of application, designate the jurisdictions that are party to the PCT in which the applicant wishes to obtain patents. Within a predetermined time after the PCT filing date, the applicant desiring to obtain patents must take steps to enter the “national/jurisdictional Phase” in designated jurisdictions such as regions and/or countries by filing a national/jurisdictional phase application in the designated regions and/or countries based on the International patent application. The predetermined time depends upon the jurisdiction but in all cases is greater than the 12 months offered by the Paris Convention. As such, the applicant can easily reserve numerous jurisdictional filing dates by filing the PCT application and designating the desired jurisdictions upon filing.

The PCT also offers an International Search And Written Opinion prepared by an International Search Authority (ISA) that is delivered before the predetermined time expires, and an applicant can additionally apply for Preliminary Examination as desired. A PCT patent application is published 18 months after its filing date or, if applicable, its priority date. Further details on the Patent Cooperation Treaty can be found at http://www.wipo.int.

The PCT may be used in conjunction with the Paris Convention (or “internal” priority systems offered by individual jurisdictions) under many circumstances. For example, under the Paris Convention a first filed application may be used as a priority application for a PCT application; in such a case the predetermined time within which to undertake National/Jurisdictional procedures is computed from the date of filing the priority application.

A recent change to the PCT filing procedure has removed the requirement that an Applicant manually designate the jurisdictions of interest and has instead enabled the Applicant to automatically designate all PCT contracting states. This has the effect of simplifying the procedure for Applicants and reducing the chance that designation of a desired contracting state is missed and therefore forgone under the PCT.

U.S. Patent Application Publication No. 2005/0038683 (Leem) discloses a system and method for enabling intellectual property information filed for patent in at least one patent office to be filed in another requested country not by the original applicant or inventor of the filed patent application, but by a requesting resident of the country in which it is desired to file a patent application. During the method, an original applicant or inventor uploads data respecting a patent application, and sets contract terms. A requesting resident enters search terms specific to the intellectual property that is desired. The system matches the requesting resident with the uploaded patent application data based on the search terms. The original resident then negotiates with one or more requesting residents about the contract terms using, for example, a chat server and/or e-mail. Once the requesting resident has been chosen and the contract terms agreed-upon, a contracting means module makes a contract document representing the contract terms, and transmits the contract document to the contracting parties for review and electronic signature.

The above-described system to Leem seeks to put buyers and sellers of intellectual property information together. However, the system suffers from several drawbacks. One such drawback is the system's inability to enable original applicants or inventors to specify which jurisdictions are individually available for contracting. A requesting resident seeking to contract with respect to a particular jurisdiction has no way of knowing whether the original applicant or inventor already has plans for the jurisdiction. The requesting resident therefore may be reluctant to contact the original applicant or inventor without such knowledge for fear of identifying themselves as a potential infringer or licensing campaign target.

Another drawback with the Leem system is the requirement for the requesting resident and the original applicant or inventor to set, negotiate and manage complex terms for all of the contracts. Such terms include ownership provisions, financing provisions, default penalties, communications requirements, dispute resolution provisions, and so forth. As a practical matter, negotiations with multiple requesting residents, in some cases communicating using various languages, can be nearly impossible to manage. This complexity can easily frustrate the process.

A further drawback with the Leem system is that it fails to take into account the deadlines inherent in obtaining patents. For example, Leem suggests that non-disclosed intellectual property information may be the subject of a contract, but fails to take into account that a priority date or International filing date may be unusable by a requesting resident due to an expiry of critical time period before or during negotiations. Also, using the Leem system, a requesting resident could conceivably enter and delay negotiations with the original applicant or owner until such time as a critical deadline has passed or is impractical to meet, or a barring publication has occurred. Such a tactic could remove the ability of the original applicant to secure protection in the subject jurisdiction, thereby providing the requesting resident freedom to operate as regards the invention in the subject jurisdiction.

The typical practice of PCT Applicants is file national and/or regional patent applications based on their PCT applications in only certain jurisdictions. The remaining jurisdictions are not filed-in, and the respective deadlines pass without incident.

It is an object of an aspect of the following to provide a system and method for facilitating transfer of an intellectual asset that addresses the above-mentioned disadvantages.

### SUMMARY OF THE INVENTION

The following provides a method and system for providing PCT Applicants an opportunity to capture value for their rights to file national and/or regional patent applications that they would not have otherwise used. These rights may themselves be considered intellectual assets because their value stems from the underlying intellectual property: the proposed invention disclosed in the PCT application.

Introduced herein, and used throughout the description is the concept of a “PCT option”. A PCT option or simply, “option” as described herein refers to the right (but not the obligation) made automatically available to a PCT Applicant, upon correct filing of their PCT patent application, to file national and/or regional patent applications in numerous countries or regions and have the national and/or regional patent applications treated by the individual nations or regions as though they were filed on the PCT filing date (“International Filing Date”). A PCT option expires after a predetermined time, depending upon the jurisdiction to which it pertains. For example, a Canadian PCT option expires after 30 months from the International Filing Date, or the priority date of the PCT Application, whichever is earlier (Canada is somewhat unique among PCT member states in that Canada offers a 12 month extension of time for national entry, to 42 months after the priority date, with payment of a late fee).

A single PCT Application can be thought of as automatically “generating” over 130 PCT options by virtue of the automatic designation of PCT member states. The PCT options are generally transferable from the original PCT Applicant or owner to a third party for use by the third party.

In accordance with an aspect, there is provided a method for facilitating transfer of an intellectual asset, comprising:

receiving electronic patent application data respecting a primary patent application;

creating and storing a plurality of option records, each option record respectively including data relating to an option to file a patent application in a respective secondary jurisdiction based on the primary patent application;

receiving authorization to make at least one option individually available for transfer;

modifying at least one option record in accordance with the authorization;

permitting third parties to view data relating to which options are individually available for transfer.

In accordance with another aspect, there is provided a system for facilitating transfer of an intellectual asset, comprising:

a data interface receiving electronic patent application data respecting a primary patent application;

a processor creating a plurality of option records, each option record respectively including data relating to an option to file a patent application in a respective secondary jurisdiction based on the primary patent application;

a storage device storing the plurality of option records;

a first input device interface receiving authorization to make at least one option individually available for transfer;

the processor modifying at least one option record in accordance with the authorization;

a second input device permitting third parties to view data relating to which options are individually available for transfer.

In accordance with another aspect, there is provided a method of transferring an intellectual asset, comprising:

receiving a plurality of exercisable options to file in secondary jurisdictions respective secondary patent applications that carry benefits of a first filing date of a primary patent application;

posting the availability of a plurality of the plurality of options for individual transfer as separate assets;

in response to an offer, transferring at least one of the options to a new owner.

In accordance with another aspect, there is provided a method of facilitating transfer of an intellectual asset, comprising:

receiving option data relating to a time-limited option owned by a first party to file in a secondary jurisdiction a secondary patent application that carries benefits of a first filing date of a primary patent application filed in a first jurisdiction;

until expiration of a bidding period, receiving bid data relating to at least one bid for purchase of the time-limited option and its respective bidder;

transferring the time-limited option from the first party to second party that is the highest bidder for a first consideration.

In accordance with another aspect, there is provided a computer readable medium embodying a computer readable program for facilitating transfer of an intellectual asset, the computer program comprising:

computer program code receiving electronic patent application data respecting a primary patent application;

computer program code creating and storing a plurality of option records, each option record respectively including data relating to an option to file a patent application in a respective secondary jurisdiction based on the primary patent application;

computer program code receiving authorization to make at least one option individually available for transfer;

computer program code modifying at least one option record in accordance with the authorization;

computer program code permitting third parties to view data relating to which options are individually available for transfer.

In accordance with another aspect, there is provided a computer readable medium embodying a computer program for transferring an intellectual asset, the computer program comprising:

computer program code receiving a plurality of exercisable options to file in secondary jurisdictions respective secondary patent applications that carry benefits of a first filing date of a primary patent application;

computer program code posting the availability of a plurality of the plurality of options for individual transfer as separate assets;

computer program code transferring at least one of the options to a new owner in response to an offer.

In accordance with another aspect, there is provided a computer readable medium embodying a computer program for facilitating transfer of an intellectual asset, the computer program comprising:

computer program code receiving option data relating to a time-limited option owned by a first party to file in a secondary jurisdiction a secondary patent application that carries benefits of a first filing date of a primary patent application filed in a first jurisdiction;

computer program code receiving bid data relating to at least one bid for purchase of the time-limited option and its respective bidder until expiration of a bidding period;

computer program code transferring the time-limited option from the first party to second party that is the highest bidder for a first consideration.

The word “comprising” as used is intended to be construed in a non-limiting manner, as is commonly used before, for example, the Canadian Intellectual Property Office or the United States Patent And Trademark Office.

The primary patent application filed in a first jurisdiction is preferably a Patent Cooperation Treaty (PCT) patent application filed in a recognized PCT receiving office. The PCT is useful for this method and system because the respective deadlines for national/regional phase entry (i.e. expiry of PCT options) all fall after the publication date—a useful feature for public bidding on PCT options.

The method and system described herein provide a number of benefits. For example, the original owner of the primary patent application can make available for transfer certain of the original owner's options to file patent applications in secondary jurisdictions, while still retaining the options that are more directly usable by the original owner. Thus, the original owner has the ability to capture value for what has heretofore been generally considered a valueless byproduct of the patenting procedure, at very low cost and inconvenience.

For example, the Patent Cooperation Treaty provides over 130 “secondary” filing dates with the filing of the International, or “primary”, patent application. These filing dates may be considered options to file secondary patent applications within respective predetermined times. While the original owner expects to use some of these options, according to the prior art the majority of options in the vast majority of PCT applications are not used by the original owner and therefore expire worthless. By providing the system described herein, the original owner is able to both make available some of the options for individual transfer as intellectual assets and facilitate their transfer to an interested buyer.

Should the original owner receive no offers for options made available for transfer then, as has been the case in the past, the options expire worthless. On the other hand, should a third party purchase one or more of the options, the original owner gains some return on their investment for little cost and time invested.

Profits gained can be employed by the original owner to fund their business.

Because the original owner may have previously disregarded unwanted options as valueless byproducts because they ascertained that there would be no return on investment for the unwanted options, the original owner may be willing to sell the unwanted options at a reasonably low cost. This of course makes the options more desirable for prospective buyers, as does the low transaction costs and effort where a simple “sale” of the options is undertaken as opposed to contract negotiations.

Another benefit inherent in the simple “sale” of the options is that the buyer is not obligated to “exercise” the purchased option. That is, as does the original owner, the buyer of the option has the choice whether to file for patent in the particular jurisdiction, or to let the option expire without action. This can have enormous benefits to a company wishing to secure its own freedom to operate without undertaking patenting costs. For example, where options are being made available for sale using the system described herein, a first company may be concerned that a competitor company will purchase an option respecting an invention that is relevant to the first company, so as to proceed to patent the invention and enforce the patent against the first company. The first company can therefore secure its own freedom to operate by purchasing the option thereby preventing a competitor from purchasing it. In a bidding environment, the first company and competitor company may each bid on the option raising its price, thereby benefiting the original owner.

### BRIEF DESCRIPTION OF THE DRAWINGS

Embodiments will now be described more fully with reference to the accompanying drawings, in which:

FIG. 1 is a conceptual diagram illustrating the filing of a PCT application “generating” multiple PCT options;

FIG. 2 is a conceptual diagram illustrating possible uses of the multiple PCT options generated upon PCT application filing;

FIG. 3 is a network diagram showing an embodiment of a system for facilitating transfer of PCT options;

FIG. 4 is a schematic diagram illustrating in additional detail the marketplace server of FIG. 3;

FIGS. 5a and 5b show several tables of a relational database used by the marketplace server of FIG. 3, according to an embodiment;

FIGS. 6 to 19 are screenshots of the user interfaces for buyers and sellers using the system to transfer PCT options.

### DETAILED DESCRIPTION OF THE EMBODIMENTS

Described herein is a method and system for facilitating transfer of an intellectual asset. During the method, electronic patent application data respecting a primary patent application is received. A plurality of option records, each option record respectively including data relating to an option to file a patent application in a respective secondary jurisdiction based on the primary patent application are created and stored. Authorization is received to make at least one option individually available for transfer, and at least one option record is modified in accordance with the authorization. Third parties are permitted to view data relating to which options are individually available for transfer.

The method and system may be embodied in a software application including computer executable instructions executed by a processing unit such as a personal computer, or other computing system environment. The software application may run alone or may be incorporated into other applications to provide enhanced functionality to those applications. The software application may include program modules including routines, programs, object components, data structures etc. and may be embodied as computer readable program code stored on a computer readable medium. The computer readable medium is any data storage device that can store data, which can thereafter be read by a computer system. Examples of computer readable media include for example read-only memory, random-access memory, CD-ROMs, magnetic tape and optical data storage devices. The computer readable program code can also be distributed over a network including coupled computer systems so that the computer readable program code is stored and executed in a distributed fashion.

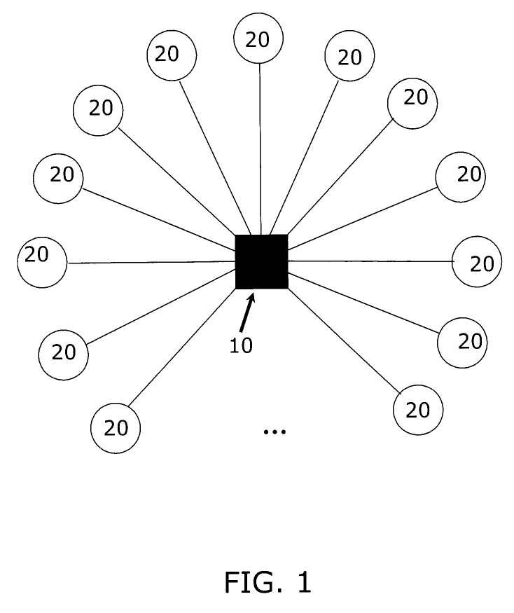

FIG. 1 is a conceptual diagram illustrating the filing of a PCT application 10 “generating” multiple PCT options 20. Though only a few PCT options 20 are shown in FIG. 1 having been generated from PCT application 10, currently over 130 PCT options 20 are created at the time of filing PCT application 10. The over 130 PCT options include both national and regional PCT options 20. For example, an option 20 to file a European patent application at the European Patent Office (EPO), which itself can designate several European countries (Germany, Spain, France etc.) and extension countries, is considered herein to be a regional PCT option 20. On the other hand, an option 20 to file a German patent application, for example, is considered herein to be a national PCT option 20.

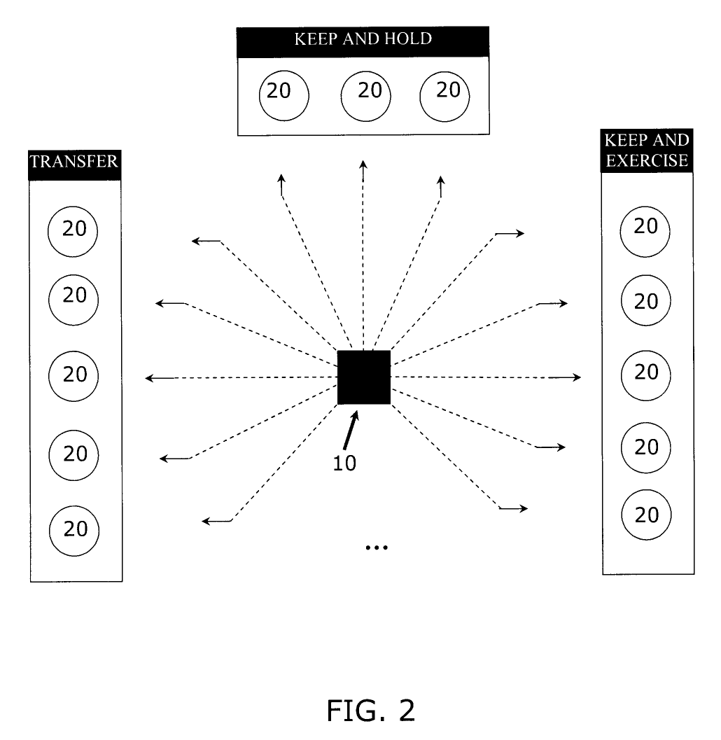

FIG. 2 is a conceptual diagram illustrating possible uses of the multiple PCT options 20 generated upon filing the PCT application 10. Several PCT options can be kept by their owner and exercised as originally intended, some can be kept by the owner and simply held, and the remainder can be transferred to a third party if desired. The system and method described herein enables a PCT application owner to relatively conveniently transfer some (or all, if desired) of their PCT options 20 to third parties, and to also track those PCT options 20 that are desired simply to be held until their expiry.

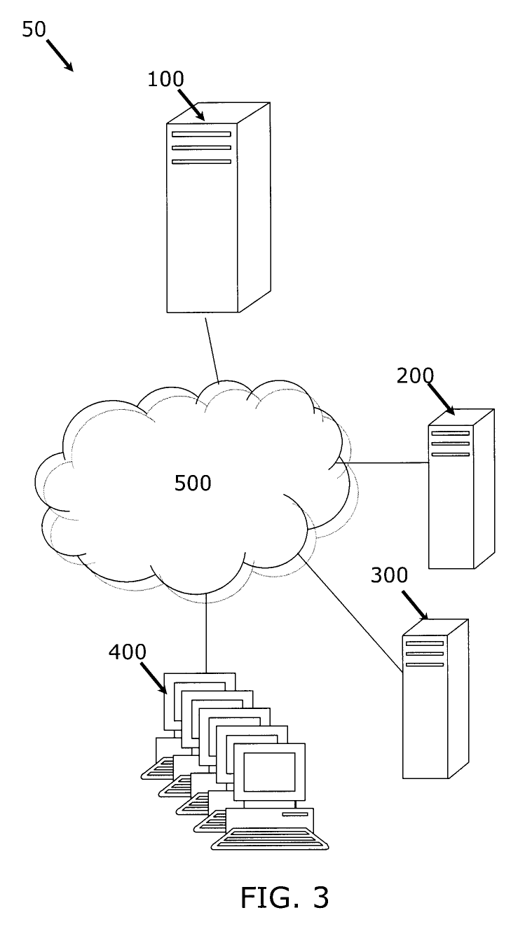

FIG. 3 is a network diagram showing an embodiment of a system 50 for facilitating transfer of PCT options. System 50 comprises a marketplace server 100 connected to a WIPO (World Intellectual Property Organization) server 200, a credit agency server 300, and user's personal computers 400 via Internet 500. Communications between each of the personal computers and servers is conducted using well-known security measures, such as the use of firewalls (not shown), secure communications protocols, and the like.

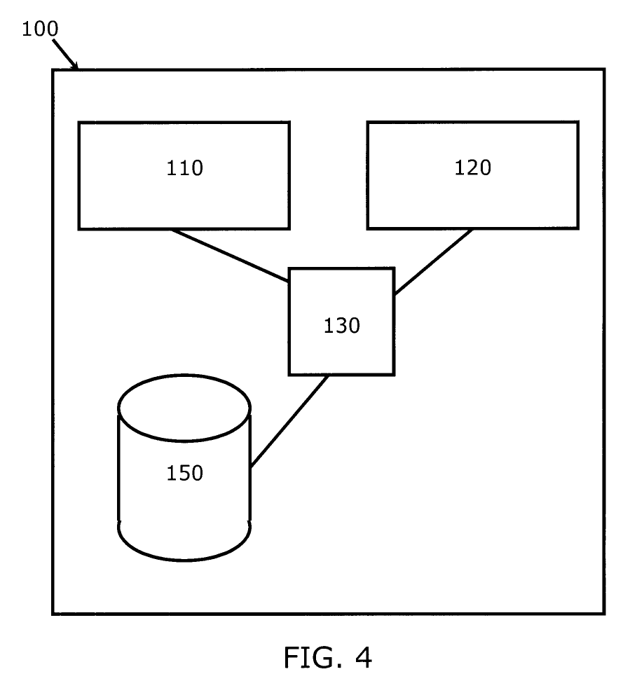

FIG. 4 is a schematic diagram illustrating in additional detail the marketplace server of FIG. 3. Marketplace server 100 comprises a data interface 110, a user interface device 120, a processor 130 and a storage device 150.

Data interface 110 is generally for receiving primary patent application data from WIPO server 200 and providing the data to processor 130 for processing and storage in storage device 150. Data interface 110 is preferably a user interface for use only by administrators of marketplace server 100 for manually or automatically uploading the primary patent application data in the form of data files. The data files include newly published patent application data, and are received periodically from WIPO server 200 at data interface 110, either by manual provision or by automatic feed. The data files are preferably in a standardized format such as is often created with the use of XML, and include details on newly published PCT patent applications, including title, inventors, priority information, and a list of the member states that have been designated in respect of the PCT patent application.

Processor 130 receives the data files provided by data interface 110, parses the data files, and creates individual PCT application records and PCT options records in a database on storage device 150. The database is of a relational variety, for example built and operated using Microsoft SQLServer™ or Oracle™. Each PCT option record that is created is associated in the database with its corresponding PCT application, and respective PCT option data, as will be described in further detail below.

User Interface 120 employs a Web server and associated business logic for enabling users to register with the system, post PCT options for transfer, sell PCT options, search for PCT options, buy PCT options and manage their account. User Interface 120 is built and run using a standard Web development platform such as is provided by Microsoft's ASP.net and Visual Studio, BEA Web logic, and the like.

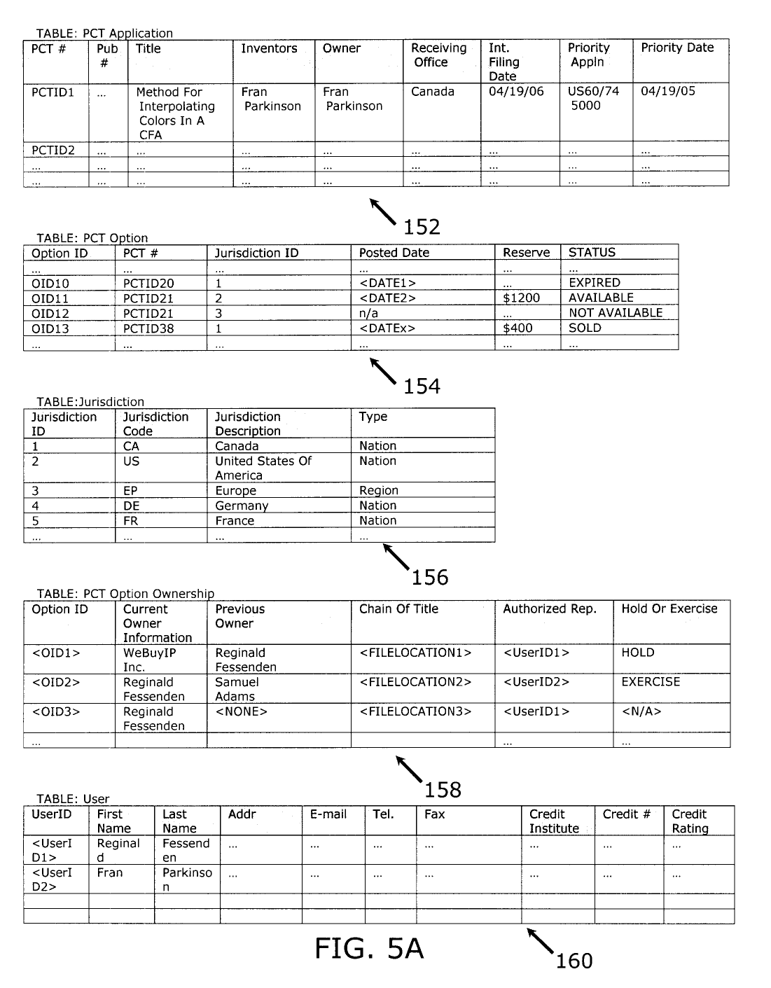

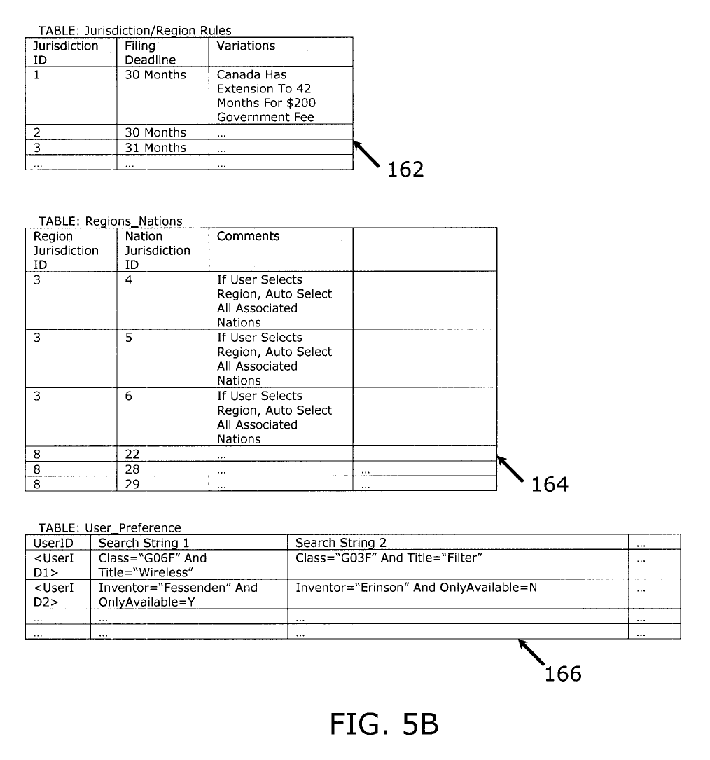

FIGS. 5a and 5b show exemplary several tables of the relational database in storage device 150. PCT Application table 152 is populated by processor 130 with data relating to the primary (i.e. PCT) patent application 10. Fields of the records in PCT Application table include the PCT # (which is in this embodiment employed as the unique key into table 152), Publication Number, Title, Inventors, Receiving Office, International Filing Date, Priority Application and Priority Application Filing Date. The International Filing Date or Priority Application Filing Date, if applicable, is employed by marketplace server 100 to calculate PCT option expiry dates and PCT option bidding periods.

PCT Option table 154 is populated by processor 130 with data relating to the designated states that are part of the primary patent application data received from the WIPO server 200 by data interface 110. It is at the time of population of PCT Option table 154 that the PCT options 20 are decoupled into logically distinct option records. That is, while options records in PCT Option table 154 are associated with respective PCT Application records via the PCT # field in table 154, each are provided with a unique Option ID, Reserve And Status fields. Initially, options records in PCT Option table 154 have a “NOT AVAILABLE” status, and no Reserve amount because, at the time of receipt of the primary patent application data, authorization has yet to be received to make the respective PCT options available for transfer.

Jurisdiction Table 156 is an administrative table that is populated once by a system administrator upon marketplace initialization and updated periodically as member states are added or removed from the PCT itself. Jurisdiction table 156 includes Jurisdiction ID, Jurisdiction Code (Country Code), Jurisdiction Description and Type fields for jurisdiction record. A jurisdiction record may be one of the Nation or Region types.

PCT Option Ownership table 158 is populated with ownership information of each PCT Options 20. Upon receipt of primary patent application data from WIPO server 200 by data interface 110, processor 130 provides an ownership record for each of the PCT options. The initial ownership information is taken from the primary patent application data and inserted in the Current Owner Information field. If no authorization is received to make a particular PCT option available, the Current Owner record for the PCT option is not changed. If authorization to make a particular PCT option available is received, then the Authorized Representative field is populated with the User ID of the registered user providing the authorization. The registered user providing the authorization to make the PCT option available is not necessarily the current owner of the PCT option, so as to account for agency relationships with the current owner.

The User table 160 is populated with data pertaining to each registered user of marketplace server 100, such as name, address and other contact details. Each user has a unique UserID and can be associated with PCT option ownership by virtue of this unique UserID. Also included in User table 160 are details relating to each user's credit. Upon registration, a user is required to enter credit information for purposes of payment of PCT option posting fees, the PCT options themselves and transaction fees, and also to provide a means to locate the user in the event of problems or misuse of system 50. The credit information is verified using credit agency server 300 in a known manner.

Jurisdiction/Region Rules table 162 is an administrative table that is populated once by a system administrator upon marketplace initialization and updated periodically as member states are added or removed from the PCT itself, notices of incompatibility are removed, or deadlines for national/regional phase entry are changed. Jurisdiction/Region Rules table 162 includes Jurisdiction ID, Filing Deadline And Variations fields to enable the business logic of marketplace server 100 to calculate national/regional phase entry deadlines and extensions, where applicable.

Regions_Nations table 164 is an administrative table that is populated once by a system administrator upon marketplace initialization and updated periodically as member states are added or removed from the PCT itself, or added or removed from regional treaties (such as the European Patent Convention). Regions_Nations table 164 is also used by the business logic of marketplace server 100 to ensure that a PCT option for a nation cannot be transferred to a different entity than the PCT option for a region of which that nation is a part. From the User perspective, the business logic determines different entities using the Authorized Representative and User tables so as to prevent two different Authorized Representatives from purchasing the two interlinked options. For example, the business logic of marketplace server 100 will not permit a first Authorized Representative to win bidding on a PCT option for Germany and a second Authorized Representative to win bidding on its counterpart PCT option for the European Patent Office. To allow otherwise this would result in conflicts as to which of the new owners truly owns the right to have a German patent, and create problems during the respective patent application procedures themselves.

User_Preference table 166 stores search strings and the like for allowing a user to have marketplace server 100 keep “watches” on PCT options being posted as available for transfer, or simply to keep watches on all published PCT applications. Other preferences may be maintained in the User_Preference table, such as settings permitting marketplace server 100 to automatically alert a user by e-mail when PCT options matching one of the user's search strings was made available for transfer

It will be understood that the tables shown in FIGS. 5A and 5B and described above are exemplary only. In the art of relational database design, various configurations having respective merits are possible, and it is not the intention of the inventor to limit the invention to a particular form of database.

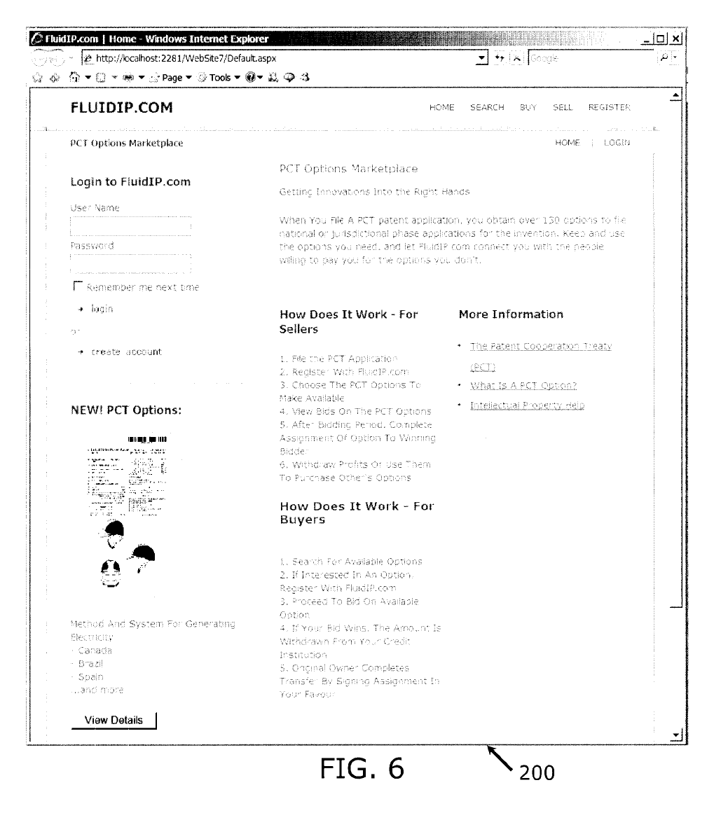

FIGS. 6 to 19 are screenshots of the user interfaces for buyers and sellers using the system to transfer PCT options. The user interfaces are provided by virtue of Web pages and forms, according the this embodiment.

FIG. 6 is a screenshot of a first “splash” Web page 200 providing a general introduction to the PCT marketplace, and the opportunity for users who have already registered to log-in to the marketplace server 100. New users are provided with the opportunity to Register. The Registration process itself is similar to that of other e-business websites such as eBay, and will not be described further in detail herein.

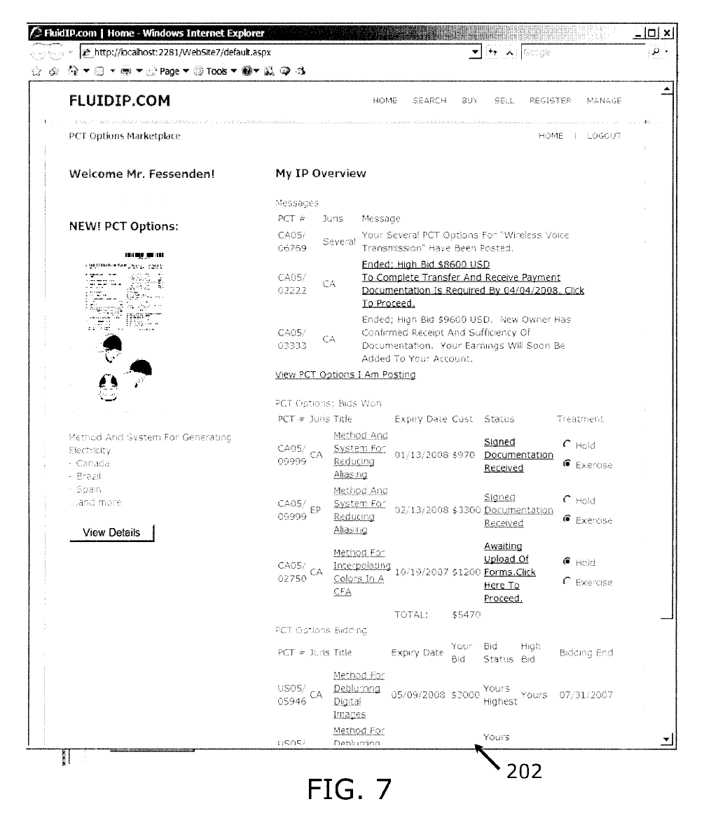

FIG. 7 is a screenshot of the Home page 202 of a registered and logged-in user. The “My IP Overview” page provides access to marketplace messages such as those informing the user that PCT options which they are authorized to make available have been made available, bids on a posted PCT option have finished and further action is required, or transactions have been finalized. The “My IP Overview” page also provides a links to a list of PCT options being posted by the user, and an overview of the Bids Won and Bidding.

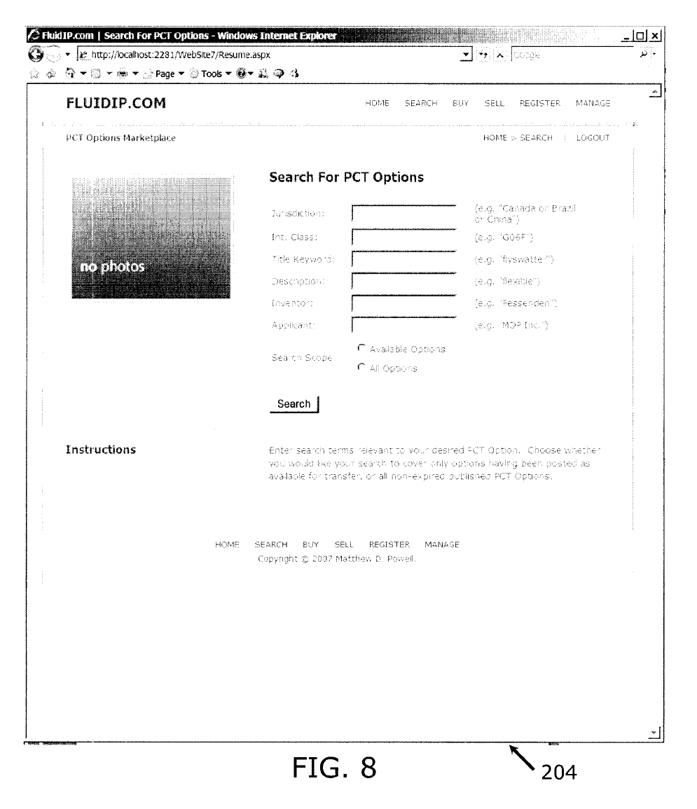

FIG. 8 is a screenshot of a Search form 204 returned when the user clicks on the Search menu button from Home page 202. Text fields are provided to user to set a search criteria for finding PCT options of interest. The user has the option of choosing the Search Scope so as to either search all published PCT options, or limit the search to only those options that have been made available for transfer.

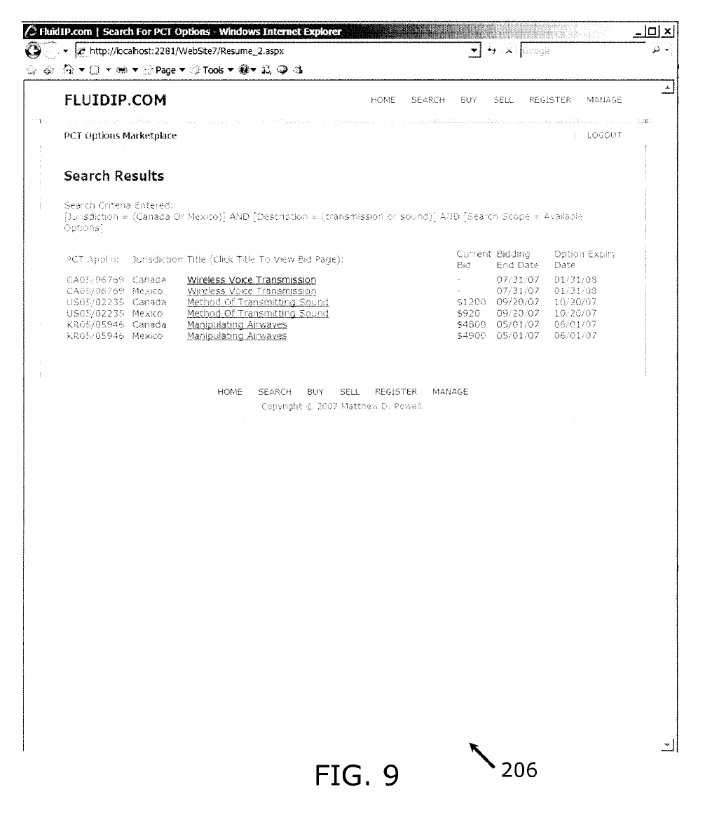

FIG. 9 is a screenshot of a Search Results page 206 returned when the user has entered a Search Criteria in Search form 204 and pressed the “Search” button. The search criteria is listed, and the results include summary details about the PCT options uncovered by the search, including PCT Application number, Jurisdiction, Title, Current Bid (If Any), Bidding End Date, and Option Expiry Date.

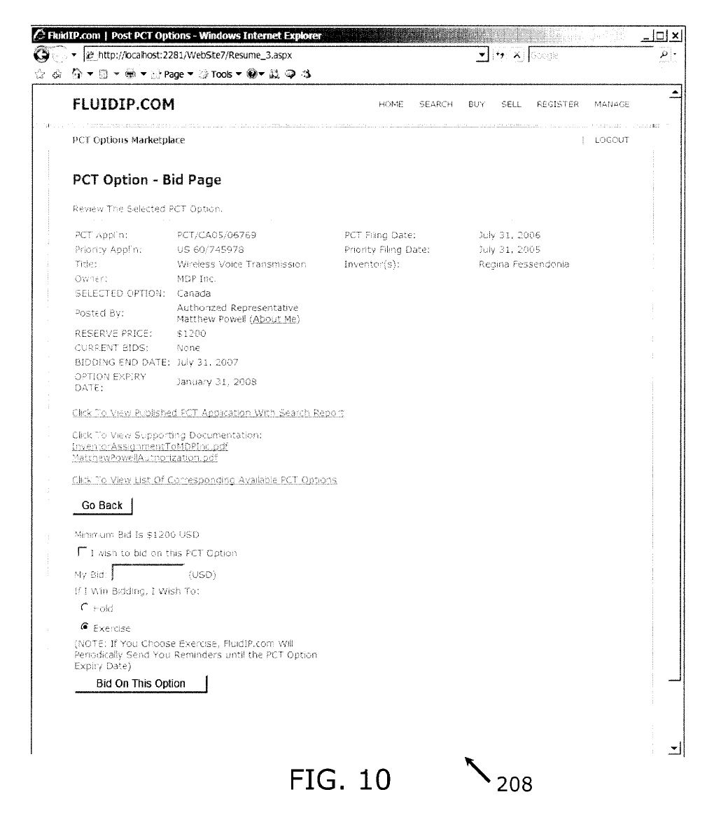

When a user clicks on the title of one of the search results for a PCT options that has been made available for transfer, the PCT Option Bid Page 208, shown in FIG. 10, is returned by marketplace server 100.

PCT Option Bid Page 208 provides the user with the opportunity to view the PCT option in further detail. The user is able to click on a link to view the published PCT application, with search report if available. The published PCT application is publicly available and may be provided by hyperlink directly to the WIPO server 200 itself. In the event that marketplace server 100 keeps the published PCT application from the primary patent application data received from the WIPO, the published PCT application may be provided by hyperlink to file storage on storage device 150.

PCT Option Bid Page 208 also provides the opportunity for users to view documentation provided by the Authorized Representative of the owner of the PCT option to assess the chain of title and the validity of the authorization. The user is also able to view a list of corresponding PCT options i.e., those for different jurisdictions stemming from the same PCT application 10.

Registered and logged-in users are able to enter a bid and a bid amount on the PCT option shown on the PCT Option Bid Page 208, and specify whether the bid is for hold or for exercise. A user will specify Hold if it is desired to simply bid on the PCT option to take it off of the marketplace thereby providing a clearance tool. A user will specify Exercise if the PCT option is expected to be exercised. While no other users will be able to learn whether the bidding user has specified Hold or Exercise, the system will suppress reminders to winning bidders as to the PCT option expiry date if Hold is selected.

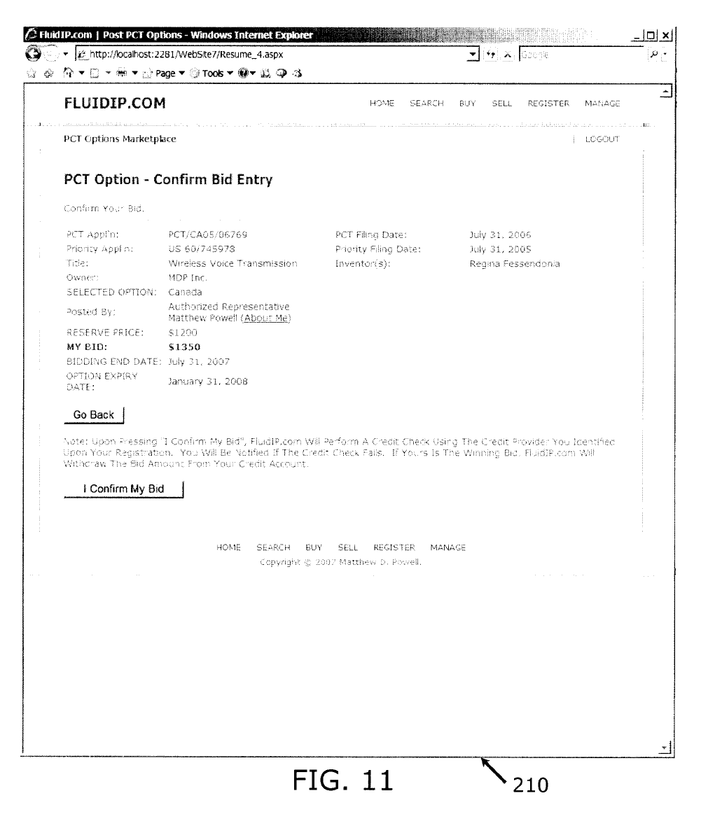

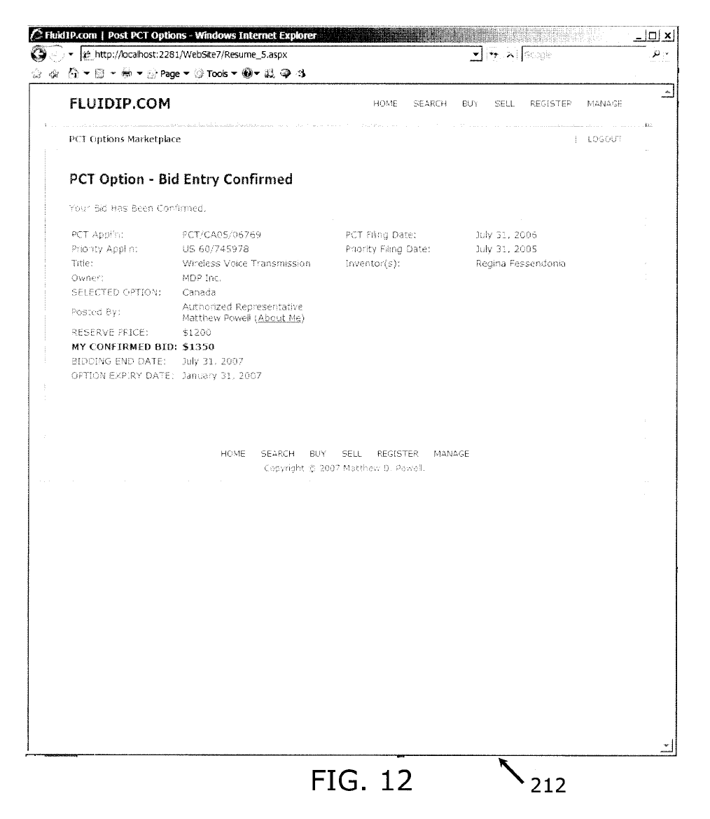

FIG. 11 shows a screenshot of the Confirm Bid Entry page 210. This page gives the bidding user the opportunity to review their bid before committing. Upon pressing the “I Confirm My Bid” button, the bid is entered and the user is taken to Bid Entry Confirmed page 212, as shown in FIG. 12.

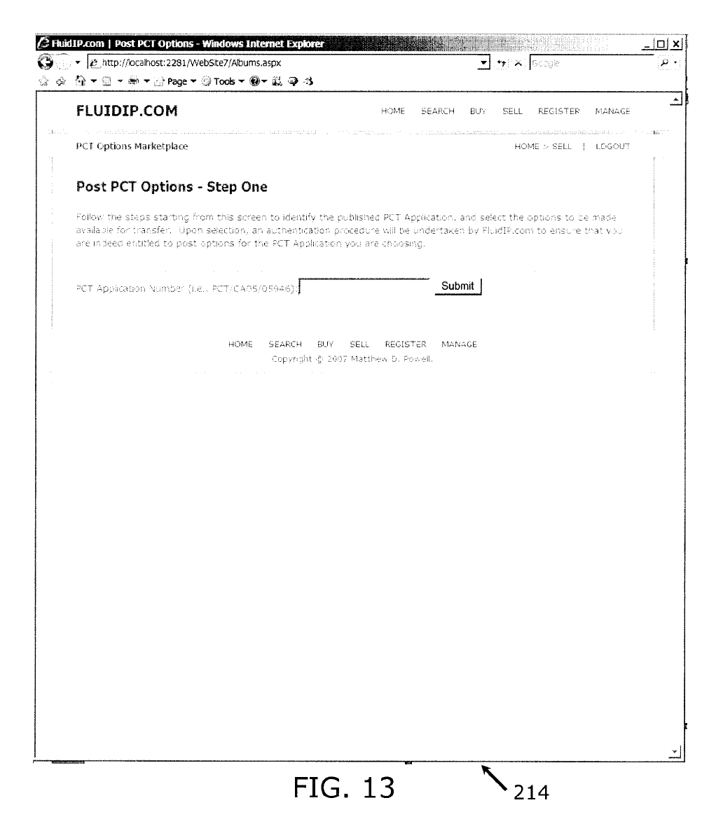

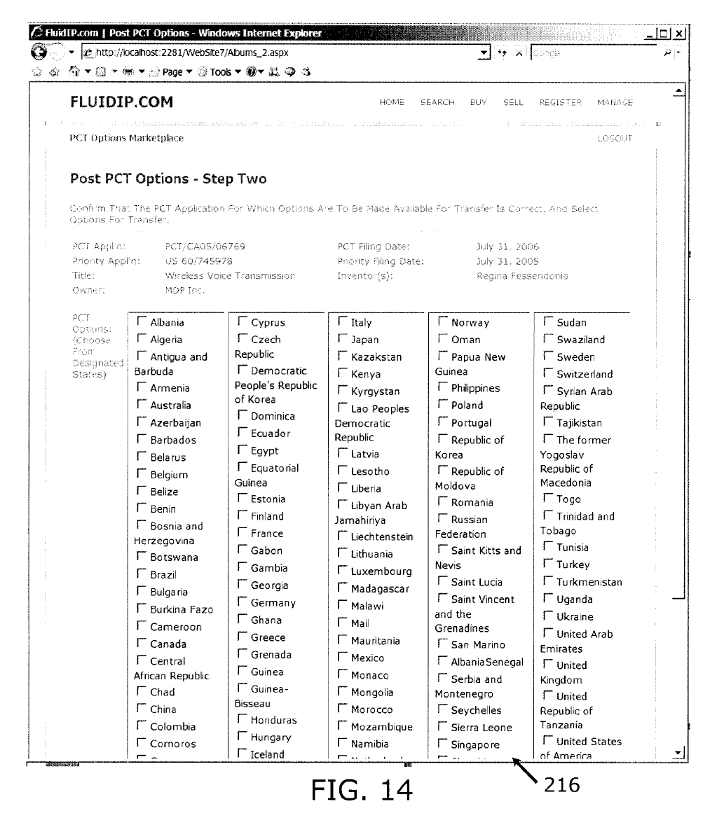

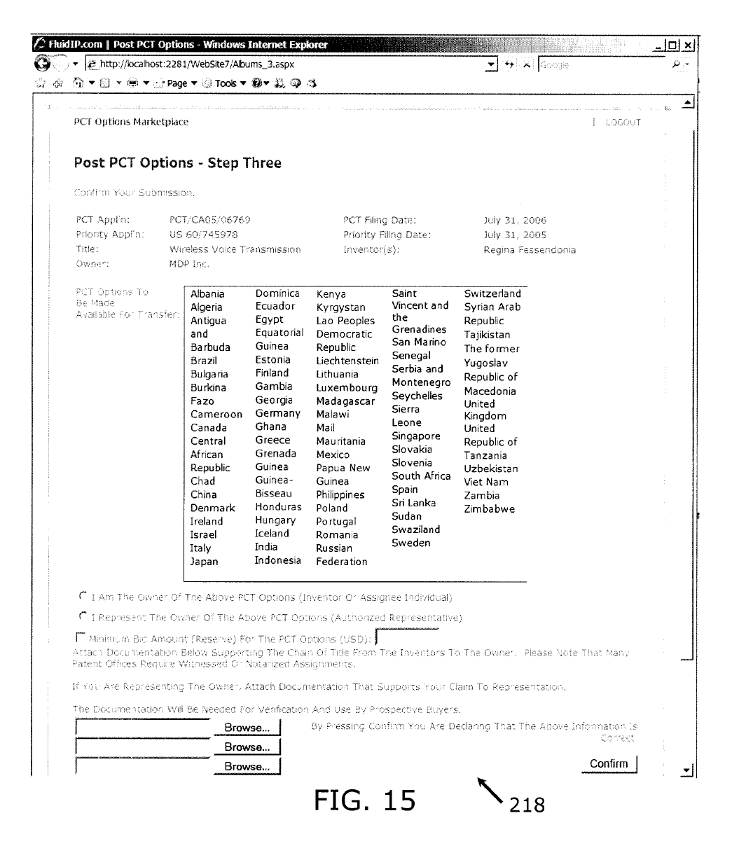

FIG. 13 is a screenshot of the Post PCT Options—Step One page 214 provided to the user upon clicking on the “Sell” link in the Menu at the top of each Web page. Step One page 214 simply requires that the user enter the PCT Application Number. When this information has been entered and the Submit button pressed, the user is taken to the Post PCT Options—Step Two page 216, as shown in FIG. 14. A brief overview of the PCT option is given based on the data in the PCT Application table, and checkboxes for each of PCT options in the PCT Option table and associated with the PCT Application are listed. The user is able at this point to check off the PCT options to make available for transfer. Upon pressing the Submit button (not shown in FIG. 14), the user is taken to the Post PCT Options—Step Three page 218 to confirm their submission, as shown in FIG. 15.

The Post PCT Options—Step Three page 218 requires that the user review the PCT options that are to be made available for transfer, and specify whether the user is the owner or a representative of the owner. The user is also able to specify a minimum bid amount for the PCT options (i.e., the “reserve”). The user is also required to upload documentation supporting the chain of title from the inventors to the current owner, and if representing the owner, documentation supporting the user's authorization to make the PCT options available for transfer. The uploaded documentation is made available to prospective buyers of the PCT options being made available in order to assist with assessments.

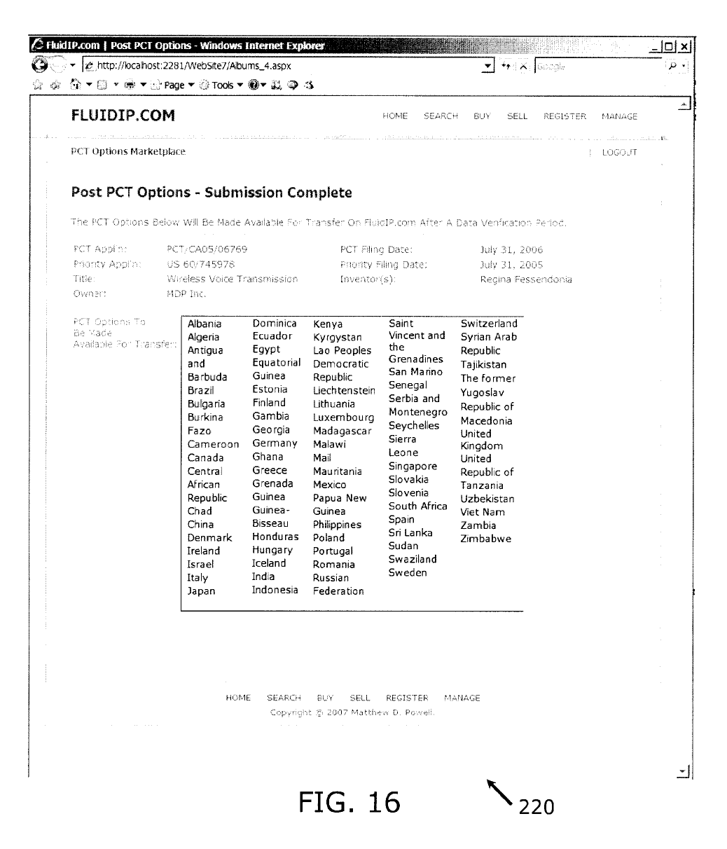

Upon Pressing the Confirm button, the marketplace server 100 returns the Post PCT Options—Submission Complete page 220, as shown in FIG. 16. The user is informed that the PCT options will be made available after a data verification period. The enables the marketplace server administrator or clerical staff to ensure that indeed documentation was uploaded and that chain of title and authorization appear to be correct. Automatic verification means may be used that employ optical character recognition and the like to provide a first pass on data verification. Those wishing to buy PCT options will also provide their own verification.

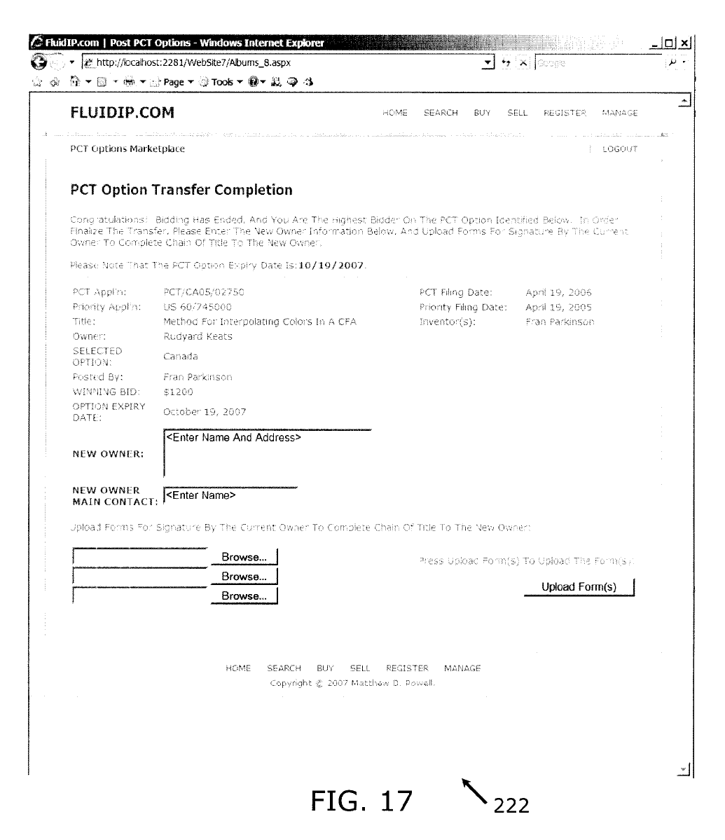

FIG. 17 shows a PCT Option Transfer Completion page 222 available only to the user who has won bidding on a PCT option. The user is required to enter the details about the new owner, and upload their own forms for signature by the current owner to complete the chain of title to the new owner.

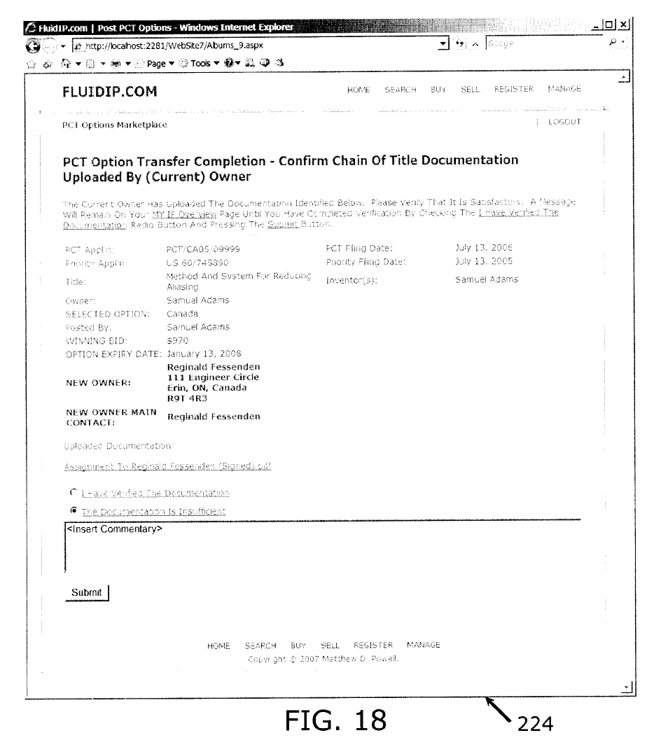

FIG. 18 shows a PCT Option Transfer Completion—Confirm Chain Of Title Documentation Uploaded By (Current) Owner page 224. This is the page seen by a user who has uploaded the necessary forms as described and shown in FIG. 17, and is receiving the completed forms from the Current owner to complete the chain of title. The user is able to view and verify the signed documentation. In the event that the signed documentation is insufficient, the user is given the opportunity to provide commentary which will be seen by the current owner. Such commentary may include a note indicating that the file is corrupt, unreadable or the signatures are not witnessed.

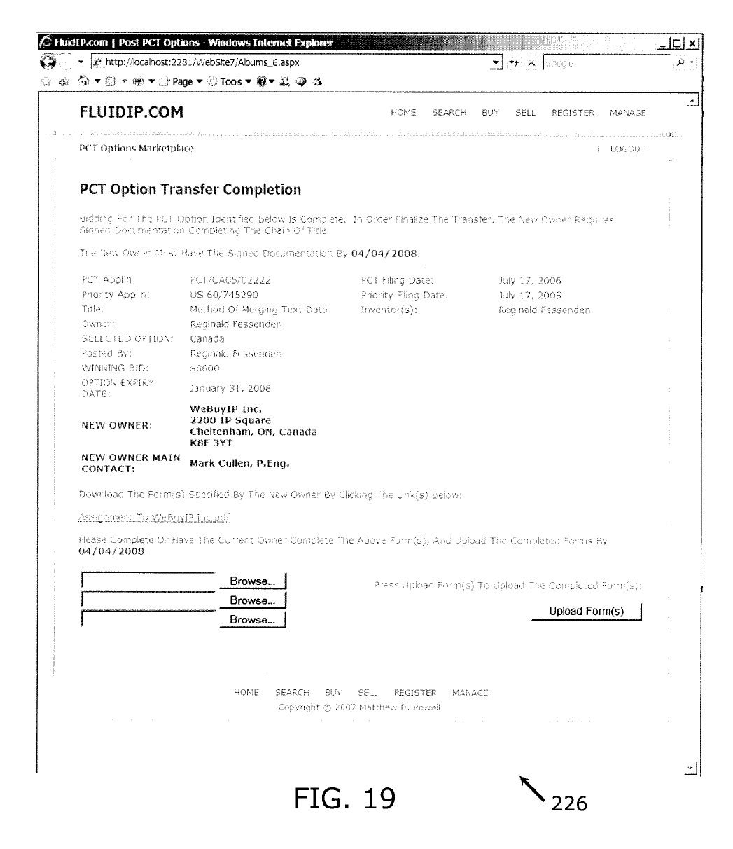

FIG. 19 is a PCT Option Transfer Completion page 226 seen by a user who has transferred a PCT option to a new owner and is now required to have documentation completing the chain of title signed by the current owner. The user is able to download the proposed chain of title documentation, have it signed, and upload it for review by the authorized representative of the new owner, as shown in FIG. 18.

The system and method described herein may be used in conjunction with other and additional systems as part of a larger service. For example, the marketplace server 100 may be integrated with or otherwise provide data to portfolio management software packages so as to enable prospective buyers to evaluate PCT options as part of an overall portfolio building and marketplace clearing strategy. Portfolio managers may also wish to integrate their systems with the marketplace server 100 to capture value for PCT options that would otherwise lapse.

It should be borne in mind by prospective users of the systems and methods described herein that careful planning be done to ensure that PCT options transferred to someone else do not unduly hinder the original owner's freedom to operate in a particular jurisdiction at a later time. One strategy to hedge this risk is to keep and use a large number of PCT options for the base-level innovations to cover a large geographical area, and transfer the PCT options for the incremental improvements to new owners. Doing so provides some mechanisms for the owner of the base-level innovations to at least negotiate their own freedom to operate, and encourages buyers of the incremental improvements to become licensees of the base-level intellectual property upon which the incremental improvements are based.

Although embodiments have been described, those of skill in the art will appreciate that variations and modifications may be made without departing from the spirit and scope of the invention defined by the appended claims.

What is claimed is:

1. A method for facilitating transfer of an intellectual asset, comprising:
receiving electronic patent application data respecting a primary patent application;
creating and storing a plurality of option records, each option record respectively including data relating to an option to file a patent application in a respective secondary jurisdiction based on the primary patent application;
receiving authorization to make at least one option individually available for transfer;
modifying at least one option record in accordance with the authorization;
permitting third parties to view data relating to which options are individually available for transfer.

2. The method of claim 1, further comprising:
creating and storing an electronic primary patent application record based on the electronic patent application data; and
electronically associating the electronic primary patent application record with corresponding option records.

3. The method of claim 1, wherein the data relating to an option includes a respective jurisdiction identifier.

4. The method of claim 1, wherein the electronic patent application data is a data file including a primary patent application identifier and a plurality of jurisdiction identifiers.

5. The method of claim 1, wherein modifying the at least one option record comprises:
modifying availability data relating to the at least one option record.

6. The method of claim 1, wherein the authorization to make one or more of the options individually available for transfer comprises an electronic instruction from an authorized person.

7. The method of claim 1, further comprising:
receiving a bid from a third party respecting one or more options individually available for transfer;
in the event that the offer satisfies acceptability criteria, conducting a transaction including transferring the one or more options to the third party.

8. The method of claim 7, wherein the acceptability criteria for an option is predetermined.

9. The method of claim 8, wherein the acceptability criteria for an option is a minimum price.

10. The method of claim 7, wherein the acceptability criteria for an option is determined after a time period based on other offers having been received respecting the option during the time period.

11. The method of claim 5, wherein the transaction comprises:
modifying the ownership data relating to the one or more options for which an offer was received; and
associating authorization documentation with the transaction.

12. A system for facilitating transfer of an intellectual asset, comprising:
a data interface receiving electronic patent application data respecting a primary patent application;
a processor creating a plurality of option records, each option record respectively including data relating to an option to file a patent application in a respective secondary jurisdiction based on the primary patent application;
a storage device storing the plurality of option records;
a user interface device receiving authorization to make at least one option individually available for transfer;
the processor modifying at least one option record in accordance with the authorization;
the user interface device permitting third parties to view data relating to which options are individually available for transfer.

13. The system of claim 12, wherein the storage device stores an electronic primary patent application record based on the electronic patent application data; the processor electronically associating the electronic primary patent application record with corresponding option records.

14. The system of claim 12, wherein the data relating to an option includes a respective jurisdiction identifier.

15. The system of claim 12, wherein the electronic patent application data is a data file including a primary patent application identifier and a plurality of jurisdiction identifiers.

16. The system of claim 12, wherein during the modifying the at least one option record the processor modifies availability data relating to the at least one option record.

17. The system of claim 12, wherein the authorization to make one or more of the options individually available for transfer comprises an electronic instruction from an authorized person.

18. The system of claim 12, further comprising:
the user interface device receiving a bid from a third party respecting one or more options individually available for transfer;
wherein the processor conducts a transaction including transferring the one or more options to the third party in the event that the offer satisfies acceptability criteria.

19. The system of claim 18, wherein the acceptability criteria for an option is predetermined.

20. The system of claim 19, wherein the acceptability criteria for an option is a minimum price.

21. The system of claim 18, wherein the acceptability criteria for an option is determined by the processor after a time period based on other offers having been received respecting the option during the time period.

22. The system of claim 16, wherein during the transaction the processor modifies the ownership data in the storage device relating to the one or more options for which an offer was received, and associates authorization documentation with the transaction.

23. The system of claim 22, wherein the authorization documentation is received at the second user interface from the third party.

24. A method of facilitating transfer of an intellectual asset, comprising:
receiving information respecting a plurality of exercisable options to file in secondary jurisdictions respective secondary patent applications that carry benefits of a first filing date of a primary patent application;
hosting a public forum for posting on behalf of the owner of the exercisable options the availability of a plurality of the plurality of options for individual transfer as separate assets;
in response to an offer, facilitating transferring at least one of the options to a new owner.

25. The method of claim 24, wherein the primary patent application is a Patent Cooperation Treaty application.

28. The method of claim 24, further comprising:
the new owner exercising at least one of the transferred options by filing as applicant the second patent application in the second jurisdiction.

27. The method of claim 24, wherein the options expire after a respective time, the method further comprising:
suppressing a reminder to the new owner to facilitate holding at least one of the transferred options past its expiry time without exercise.

28. A method of facilitating transfer of an intellectual asset, comprising:
receiving option data relating to a time-limited option owned by a first party to file in a secondary jurisdiction a secondary patent application that carries benefits of a first filing date of a primary patent application filed in a first jurisdiction;
until expiration of a bidding period, receiving bid data relating to at least one bid for purchase of the time-limited option and its respective bidder;
transferring the time-limited option from the first party to second party that is the highest bidder for a first consideration.

29. The method of claim 28, further comprising the second party transferring for a second consideration the option to file the second application in the second jurisdiction to a third party prior to the option expiration date.

30. The method of claim 29, wherein the first consideration and the second consideration are unequal.

31. The method of claim 30, wherein the second consideration is greater than the first consideration, thereby conferring a profit on the time-limited option to the second party.

32. A computer readable medium embodying a computer readable program for facilitating transfer of an intellectual asset, the computer program comprising:
computer program code receiving electronic patent application data respecting a primary patent application;
computer program code creating and storing a plurality of option records, each option record respectively including data relating to an option to file a patent application in a respective secondary jurisdiction based on the primary patent application;
computer program code receiving authorization to make at least one option individually available for transfer;
computer program code modifying at least one option record in accordance with the authorization;
computer program code permitting third parties to view data relating to which options are individually available for transfer.

33. A computer readable medium embodying a computer program for facilitating transfer of an intellectual asset, the computer program comprising:
computer program code receiving information respecting a plurality of exercisable options to file in secondary jurisdictions respective secondary patent applications that carry benefits of a first filing date of a primary patent application;
computer program code creating a public forum for posting on behalf of the owner of the options the availability of a plurality of the plurality of options for individual transfer as separate assets;
computer program code transferring at least one of the options to a new owner in response to an offer.

34. A computer readable medium embodying a computer program for facilitating transfer of an intellectual asset, the computer program comprising:
computer program code receiving option data relating to a time-limited option owned by a first party to file in a secondary jurisdiction a secondary patent application that carries benefits of a first filing date of a primary patent application filed in a first jurisdiction;
computer program code receiving bid data relating to at least one bid for purchase of the time-limited option and its respective bidder until expiration of a bidding period;
computer program code transferring the time-limited option from the first party to second party that is the highest bidder for a first consideration.

35. A method for facilitating transfer of an intellectual asset, comprising:
receiving electronic patent application data relating to a primary patent application and the availability for transfer of at least one option to file a secondary patent application in a respective secondary jurisdiction based on the primary patent application;
creating and storing at least one option record based on the patent application data;
permitting public viewing of data relating to the at least one option record.

36. The method of claim 35, wherein the data relating to an option includes a respective jurisdiction identifier.

37. The method of claim 35, further comprising:
receiving electronic data relating to an offer to buy the at least one option.

38. The method of claim 35, further comprising:
receiving an offer respecting one or more of the options;
in the event that the offer satisfies acceptability criteria, conducting a transaction including transferring the one or more options to the third party.

39. A system for facilitating transfer of an intellectual asset, comprising:
a data interface receiving electronic patent application data respecting a primary patent application and the availability for transfer of at least one option to file a secondary patent application in a respective secondary jurisdiction based on the primary patent application;
a processor creating at least one option record based on the patent application data;
a storage device storing the at least one option record;
a user interface device permitting public viewing access to the at least one option record.

40. The system of claim 39, wherein the data relating to an option includes a respective jurisdiction identifier.

41. The system of claim 39, wherein the electronic patent application data is a data file including a primary patent application identifier and a plurality of jurisdiction identifiers.

42. A method of facilitating transfer of an intellectual asset, comprising:
receiving information respecting at least one exercisable option to file in a respective secondary jurisdiction a secondary patent application based on a primary patent application; and
creating a public forum for posting on behalf of the owner of the at least one option the availability of the at least one option for individual transfer as a separate asset.

43. The method of claim 42, further comprising:
receiving from a third party an offer relating to at least one available option;
in response to the offer, transferring at least one of the options to the third party.

44. The method of claim 42, wherein the primary patent application is a Patent Cooperation Treaty application.
